(19) United States
(12) Patent Application Publication
(10) Pub. No.: US 2014/0000787 A1
(43) Pub. Date: Jan. 2, 2014

(54) HOT-MELT ADHESION COMPOSITION, HOT-MELT ADHESIVE SHEET AND ADHESION METHOD

(71) Applicants: Yoshitomo Ono, Tokyo (JP); Yumiko Amino, Tokyo (JP)

(72) Inventors: Yoshitomo Ono, Tokyo (JP); Yumiko Amino, Tokyo (JP)

(73) Assignee: LINTEC CORPORATION, Tokyo (JP)

(21) Appl. No.: 13/985,059

(22) PCT Filed: Feb. 8, 2012
(86) PCT No.: PCT/JP2012/052852

§ 371 Date: Sep. 18, 2013

(30) Foreign Application Priority Data
Feb. 14, 2011 (JP) 2011-028579

(51) Int. Cl. C09J 9/00; C09J 5/06

(52) U.S. Cl. CPC C09J 9/00; C09J 5/06
USPC 156/79; 252/62.63

(57) ABSTRACT

The hot-melt adhesive composition contains a hot-melt adhesive, a ferromagnetic substance, and a foaming agent that foams when heated, and the hot-melt adhesive composition has: a surface magnetic force of 20 mT or more; a surface magnetic force after heating for adhesion of 5 mT or less; and a volume change ratio due to heating for adhesion of 110% to 400%. The hot-melt adhesive composition may be formed into a sheet-like shape to provide a hot-melt adhesive sheet, which exhibits an excellent adhesive force by heating and which also exhibits a sufficient temporarily fixing force due to magnetic force at the initial stage, but the magnetic force is sufficiently reduced after heating, so that the occurrence of irregularity on the surface due to magnetic force lines after heating can be suppressed.

### TECHNICAL FIELD

The present invention relates to a hot-melt adhesive composition, a hot-melt adhesive sheet, and an adhesion method which are used for bonding a member and another member that comprises a ferromagnetic material or for bonding members both comprising ferromagnetic materials with each other.

### BACKGROUND ART

An adhesive sheet has been conventionally used for bonding a member such as a reinforcing member to a steel sheet such as, for example, an automobile door. If the adhesive sheet has a large adhesive force in the initial stage of bonding work, then problems may occur when the member comes out of alignment to the steel sheet, such as that the re-bonding of the member may be difficult, or even if the re-bonding would be possible, the adhesive of the adhesive sheet may remain on the surface of the steel sheet. Therefore, an adhesive sheet having good workability is needed which can be temporarily fixed to a steel sheet without adhesive force in the initial stage of bonding work and then strongly adhere thereto.

To this end, Patent Literatures 1 and 2 propose a reinforcing sheet for steel sheets that comprises a resin layer obtained by mixing magnetic powder and foaming agent to rubber-based synthetic resin and a constraint layer laminated on the resin layer. When using such a reinforcing sheet for steel sheets, the reinforcing sheet is attached by magnetic force to a certain location of the steel sheet, temporarily fixed to the location, and then heated for fusion bonding thereby to adhere to the steel sheet.

However, the resin layer of the above reinforcing sheet for steel sheets employs a rubber-based adhesive, which may result in insufficient adhesive force and poor solvent or chemical resistance, thus being problematic.

In contrast, Patent Literature 3 proposes a re-attachable adhesive sheet that employs an adhesive composition containing a hot-melt adhesive and a ferromagnetic substance. Patent Literature 4 also proposes an adhesive sheet that employs an adhesive composition containing a hot-melt adhesive and a ferromagnetic substance. When using such an adhesive sheet, the adhesive sheet is interposed between one member that comprises a ferromagnetic material and another member that comprises a ferromagnetic material thereby to temporarily fix them to each other, and the adhesive sheet is then heated to cause both members to adhere to each other. This adhesive sheet employs a hot-melt adhesive, which allows the adhesive force to be sufficient as that of an adhesive and provides good solvent resistance and chemical resistance.

### PRIOR ART LITERATURE

### Patent Literature

[Patent Literature 1] Japanese Patent Publication No. 2006-315216 [Patent Literature 2] Japanese Patent Publication No. 2006-315234
[Patent Literature 3] International Patent Publication No. WO2009/119883
[Patent Literature 4] International Patent Publication No. WO2009/119885

### SUMMARY OF THE INVENTION

### Problems to be Solved by the Invention

According to the adhesive sheet described in Patent Literature 1, 2, however, a problem may possibly occur that irregularity appears on the surface of the adhesive sheet due to the effect by magnetic force lines. If such irregularity appears, then non-adhesion areas will be caused between a member as an adherend and the adhesive sheet, so that sufficient adhesive force may not be obtained.

In addition, if the magnetic force before heating (in the initial stage) is reduced in order that no magnetic force remains in the adhesive sheet after heating in consideration of negative effect of the magnetic force such as to members and human body, then the temporarily fixing force by the magnetic force before heating may be insufficient. If it is attempted to increase the magnetic force in the initial stage, then the magnetic force may not be sufficiently reduced after heating and some residual magnetic force may remain in the adhesive sheet. A heating temperature higher than the temperature (Curie temperature) at which the magnetic force disappears allows the magnetic force of the adhesive sheet to be sufficiently reduced, but an ordinary heating temperature in the production step for members may be insufficient because the magnetic material may have to be heated at least to around 300° C. due to its nature.

The present invention has been made in consideration of such circumstances, and objects of the present invention include providing a hot-melt adhesive composition and a hot-melt adhesive sheet that are able to develop an excellent adhesive force when heated and to exhibit a sufficient temporarily fixing force due to the magnetic force in the initial stage as well as to be sufficiently reduced in the magnetic force after heating thereby suppressing the occurrence of irregularity on the surface due to magnetic force lines after heating, and also providing an adhesion method using them.

### Means for Solving the Problems

In order to achieve the above objects, first, the present invention provides a hot-melt adhesive composition containing a hot-melt adhesive, a ferromagnetic substance, and a foaming agent that foams when heated, the hot-melt adhesive composition being characterized by having: a surface magnetic force of 20 mT or more; a surface magnetic force after heating for adhesion of 5 mT or less; and a volume change ratio due to heating for adhesion of 110% to 400% (Invention 1).

According to the above invention (Invention 1), the composition or the product thereof has a high surface magnetic force at ordinary temperature before being heated and can thus be temporarily fixed only by the surface magnetic force thereof to a member comprising a ferromagnetic material. Before being heated, the composition or the product has no tack or almost no tack and can therefore be easily repositioned even if the position of temporarily fixing is misaligned from a predetermined position. When being heated, the composition or the product develops a strong adhesive force thereby to tightly adhere to the member (adherend) to which it has been temporarily fixed. In addition, the heating causes the foaming agent to foam/expand thereby increasing distances among magnetic powder particles so that the surface magnetic force is significantly reduced, and hence it is possible to efficiently suppress the negative effect of the magnetic force to the member as an adherend, human body, or an electronic device, and it is also possible to suppress the occurrence of irregularity on the surface due to magnetic force lines after heating. The volume change ratio due to heating falls within the above range, then the shear force after heating may easily be maintained within a preferable range, and resin collapse of the adhesive composition can be prevented. The “adhesive composition” as used herein includes not only those before being heated but also those after being heated or after being heated and bonded.

In the above invention (Invention 1), it is preferred that the foaming agent has a foaming start temperature higher than a softening point of the hot-melt adhesive by 10° C. or more (Invention 2).

In the above invention (Invention 1, 2), it is preferred that the foaming agent is a thermally expandable microcapsule (Invention 3).

Second, the present invention provides a hot-melt adhesive sheet configured by forming the hot-melt adhesive composition (Invention 1, 2, 3) into a sheet-like shape (Invention 4).

Third, the present invention provides an adhesion method characterized by comprising: temporarily fixing a first member and a second member to each other via the hot-melt adhesive sheet (Invention 4), the first member comprising a ferromagnetic material, the second member comprising a ferromagnetic material; and thereafter heating the hot-melt adhesive sheet to develop an adhesive force of the hot-melt adhesive composition and to foam the foaming agent so that the first member and the second member adhere to each other (Invention 5).

Fourth, the present invention provides an adhesion method characterized by comprising: forming an adhesive portion on a first member, the adhesive portion comprising the hot-melt adhesive composition (Invention 1, 2, 3); temporarily fixing the first member and a second member to each other via the adhesive portion, the second member comprising a ferromagnetic material; and thereafter heating the adhesive portion to develop an adhesive force of the hot-melt adhesive composition and to foam the foaming agent so that the first member and the second member adhere to each other (Invention 6).

### Advantageous Effect of the Invention

According to the hot-melt adhesive composition and the hot-melt adhesive sheet of the present invention, it is possible to develop an excellent adhesive force when heated and to exhibit a sufficient temporarily fixing force due to the magnetic force in the initial stage as well as to sufficiently reduce the magnetic force after heating thereby suppressing the occurrence of irregularity on the surface due to magnetic force lines after heating. According to the adhesion method of the present invention using the above hot-melt adhesive composition or hot-melt adhesive sheet, adhesion work can be performed with superior workability.

### EMBODIMENTS FOR CARRYING OUT THE INVENTION

Embodiments of the present invention will hereinafter be described.

The hot-melt adhesive composition according to the present embodiment contains a hot-melt adhesive, a ferromagnetic substance, and a foaming agent that foams when heated.

The hot-melt adhesive is an adhesive that has no tack or almost no tack at ordinary temperature, but is softened/molten by being heated to develop adhesive property, and is solidified to adhere by being returned to ordinary temperature. Examples of the hot-melt adhesive include rubber-based hot-melt adhesive, polyolefin resin-based hot-melt adhesive, and polyester resin-based hot-melt adhesive. Among them, in views of the adhesive force, chemical resistance and other properties, polyolefin resin-based hot-melt adhesive and polyester resin-based hot-melt adhesive are preferable, and polyester resin-based hot-melt adhesive is particularly preferable. When applied to the surface of a member attached thereto with oil components, polyester-based and polyolefin resin-based hot-melt adhesives are particularly preferable.

Specific examples of the rubber-based hot-melt adhesive include those obtained by adding petroleum resin to styrene-isopropylene-styrene block copolymer and/or to styrene-butadiene-styrene block copolymer.

Specific examples of the polyolefin resin-based hot-melt adhesive include copolymer of propylene, ethylene and butene-1, and ethylene-vinyl acetate copolymer. A commercially available polyolefin resin-based hot-melt adhesive may include, for example, “MORESCO-MELT EP-167” available from MORESCO Corporation.

Specific examples of the polyester resin-based hot-melt adhesive include polycondensation product of dicarboxylic acid component and diol component. Examples of the dicarboxylic acid component include terephthalic acid, isophthalic acid, and lower alkyl ester thereof; malonic acid succinic acid, adipic acid, and sebacic acid. Examples of diol component include ethylene glycol, 1,3-propanediol, 1,4-butanediol, 1,5-pentanediol, 1,6-hexanediol, diethylene glycol, triethylene glycol, polyethylene glycol, cyclohexanedimethanol, neopentyl glycol, and polytetramethylene glycol. Polyester resin-based hot-melt adhesive can be obtained by using each one or more types of these dicarboxylic acid components and diol components. A commercially available polyester resin-based hot-melt adhesive may include, for example, “ER Series” available from TOYO ADL CORPORATION and “Nichigo-POLYESTER Series” (“POLYESTER SP-165”) available from The Nippon Synthetic Chemical Industry Co., Ltd.

The softening point of the hot-melt adhesive is preferably 100° C. to 200° C., more preferably 120° C. to 200° C., and most preferably 150° C. to 180° C. If the softening point of the hot-melt adhesive falls within the above ranges, the adhesive force can be developed at an ordinary heating temperature in the production step/working step for the adherend. When using a commonly available foaming agent as the foaming agent described later, the foaming agent can be dispersed into the molten hot-melt adhesive without foaming the foaming agent.

The ferromagnetic substance used for the adhesive composition according to the present embodiment is a substance capable of having spontaneous magnetization even without external magnetic field, and also include ferrimagnetic substance. Specific examples of the ferromagnetic substance include metals such as iron, nickel and cobalt, alloys (e.g., stainless steel) or oxides thereof; ferrite-series such as strontium ferrite, barium ferrite, manganese zinc ferrite, nickel zinc ferrite and copper zinc ferrite; alnico-series such as aluminum-nickel-cobalt alloy; and rare earth-series such as rare earth-transition metal-series (e.g., SmCo-series, SmFeN-series, and NbFeB-series). Among them, in view of easily and finely controlling the initial magnetic property, ferrite-series may be preferable. Especially, strontium ferrite or barium ferrite may be more preferable.

It is preferred that the ferromagnetic substance is powder (referred hereinafter to as “magnetic powder”). The average particle diameter of the magnetic powder is preferably 0.5 to 20 μm, more preferably 0.5 to 15 μm, and most preferably 1 to 5 μm.

The content ratio of the magnetic powder to 100 parts by mass of the hot-melt adhesive is preferably 100 to 400 parts by mass, more preferably 120 to 350 parts by mass, and most preferably 150 to 300 parts by mass.

The foaming agent used for the adhesive composition according to the present embodiment is to foam/expand by being heated. If the adhesive composition contains the foaming agent, the foaming agent foams/expands after heating thereby to increase distances among magnetic powder particles so that the magnetic force can be sufficiently reduced, and further, any irregularity may be prevented from occurring on the surface of the adhesive composition due to magnetic force lines and also due to the foaming in itself. The adhesive composition may foam to thereby fill the interspaces between the adhesive layer and the adherend, and a sufficient adhesive strength can thus be obtained.

Examples of the foaming agent include pyrolytic-type chemical foaming agent, pyrolytic-type inorganic foaming agent, and thermally expandable microcapsule, among which the thermally expandable microcapsule is preferable in views of high temperature controllability and high dispersibility into the hot-melt adhesive.

Examples of the pyrolytic-type chemical foaming agent include dinitrosopentamethylenetetramine (DPT), azodicarbodiamide (ADCA), p,p′-oxybis(benzenesulfonyl hydrazide) (OBSH), p-toluenesulfonyl hydrazide (TSH), p-toluenesulfonyl acetone hydrazone, hydrazodicarbonamide, and azobisisobutyronitrile (AIBN). Examples of the pyrolytic-type inorganic foaming agent include sodium hydrogen carbonate.

As the thermally expandable microcapsule, vaporized gas encapsulated capsule and in particular microcapsule encapsulating liquid-form gas may be used. Specifically, capsule shell may include polyvinyl chloride; polyacrylonitrile; methacrylate-based resin such as methyl methacrylate, norbornane methacrylate, and trimethylolpropane triacrylate; or acrylate-based resin such as benzyl acrylate and norbornane acrylate, and low-boiling-point solvent such as pentane and heptane, may be encapsulated therein.

The average particle diameter of the thermally expandable microcapsule is preferably 5 to 50 μm, and more preferably 20 to 40 μm.

It is preferred that the foaming start temperature of the foaming agent is higher than a softening point of the hot-melt adhesive by 10° C. or more. If the foaming start temperature is lower than the softening point of the hot-melt adhesive, the foaming agent may foam when it is mixed with the heated and molten hot-melt adhesive. Specifically, the foaming start temperature of the foaming agent may be preferably 110° C. to 200° C., and more preferably 140° C. to 180° C. If the foaming start temperature falls within these ranges, the foaming agent does not foam in the dispersion step for the foaming agent to the hot-melt adhesive, and the obtained adhesive composition may be heated to foam/expand thereby preventing the occurrence of irregularity on the surface due to magnetic force lines and reducing the magnetic force.

The content ratio of the foaming agent to 100 parts by mass of the hot-melt adhesive may be preferably 0.1 to 10 parts by mass, more preferably 0.2 to 7.0 parts by mass, and most preferably 0.3 to 3.5 parts by mass. If the content ratio of the foaming agent exceeds 10 parts by mass, then the shear force after heating (e.g., 150° C., 40 minutes) and adhesion may be unduly low so that the adhesive composition may possibly drop off from the adherend, and the volume of the adhesive composition may excessively expand so that resin collapse of the adhesive composition may occur. If the content ratio of the foaming agent is less than 0.1 parts by mass, then the forming/expanding will be insufficient so that the occurrence of irregularity on the surface due to magnetic force lines may not be prevented or the magnetic force may not be reduced.

The adhesive composition according to the present embodiment may contain, for example, one or more types of tackifier, antioxidizing agent, filler, and dispersant in addition to the above components, for example.

To produce the adhesive composition according to the present embodiment, it is preferred that the hot-melt adhesive, the ferromagnetic substance (magnetic powder), the foaming agent, and other components as necessary are mixed and heated to heat and melt the hot-melt adhesive, and each component is dispersed into the hot-melt adhesive. This heating temperature may be preferably lower than the foaming start temperature of the foaming agent and higher than the softening point of the hot-melt adhesive by 10° C. or more, and more preferably by 20° C. to 70° C. Mixing under a temperature within such temperature ranges allows the magnetic powder and the foaming agent to be homogeneously dispersed into the hot-melt adhesive and also allows the hot-melt adhesive to be prevented from deteriorating. Specific heating temperature may be preferably 110° C. to 200° C., more preferably 120° C. to 180° C., and most preferably 130° C. to 170° C.

The ferromagnetic substance to be mixed into the hot-melt adhesive in the above manner may be one that has been in a magnetized state or may be one that has not been in a magnetized state. In the latter case, the adhesive composition obtained after the mixing may be magnetized (subjected to magnetization). The magnetization may be performed by using well-known method, such as by using a commercially available magnetizing/demagnetizing power-supply apparatus. When the hot-melt adhesive and the magnetic powder are mixed while being heated, the ferromagnetic substance having been magnetized may be demagnetized, in which case the adhesive composition obtained after the mixing may be subjected to magnetization.

It is preferred that the adhesive composition according to the present embodiment may have a viscosity at 130° C. of 5 to 500 Pa·s, and particularly preferably of 15 to 200 Pa·s. If the viscosity falls within these ranges, the ferromagnetic substance and the foaming agent are easily dispersed into the heated hot-melt adhesive during the above production steps for the adhesive composition. The measurement of viscosity may be performed in conformity with JIS K6833 except that the sample temperature is set to be 130° C.

The adhesive composition according to the present embodiment has a surface magnetic force at ordinary temperature of 20 mT or more, and may be preferably of 25 to 100 ml. The surface magnetic force as used herein refers to, in the case of a sheet-like body, a surface magnetic force measured by a gaussmeter at a location separate by 1 cm from the surface of an adhesive sheet which is formed in sheet-like shape with a thickness of 500 μm using the above adhesive composition. In the case of a molded body other than the sheet-like body, the surface magnetic force refers to a surface magnetic force measured by a gaussmeter at a location separate by 1 cm from a surface, of the molded body of the above adhesive composition, which is expected to adhere to the adherend. If the surface magnetic force is 20 mT or more, then the adhesive composition can sufficiently be temporarily fixed only by its surface magnetic force to a member comprising a ferromagnetic material. If the surface magnetic force is 50 mT or less, then the adhesive composition can be easily repositioned even when the position of temporarily fixing is misaligned from a predetermined position.

The adhesive composition according to the present embodiment has a surface magnetic force after heating of 5 mT or less, preferably 3 mT or less, and particularly preferably 1.5 mT or less. The lower limit of the surface magnetic force is 0 mT. The surface magnetic force after heating as used herein refers to, in the case of a sheet-like body, a surface magnetic force measured by a gaussmeter at a location separate by 1 cm from the surface of an adhesive sheet which has been formed in sheet-like shape with a thickness of 500 μm using the above adhesive composition and heated at 150° C. during 40 minutes thereafter being returned to ordinary temperature. In the case of a molded body other than the sheet-like body, the surface magnetic force refers to a surface magnetic force measured by a gaussmeter at a location separate by 1 cm from a surface of the molded body of the above adhesive composition, wherein the molded body has been heated at 150° C. during 40 minutes thereafter being returned to ordinary temperature, and the surface is expected to adhere to the adherend.

If the surface magnetic force after heating of the adhesive composition is 5 mT or less, then the magnetic force is unlikely to negatively affect the temporarily fixed member (which may be referred herein to as “adherend”), human body, or an electronic device.

The adhesive composition according to the present embodiment has a volume change ratio (percentage of the volume after heating/the volume before heating) by heating/foaming of 110% to 400%, and preferably of 130% to 350%. The heating temperature is a temperature which is equal to or higher than the temperature where the hot-melt adhesive develops an adhesive force and which is equal to or higher than the foaming temperature of the foaming agent. The volume change ratio being 110% or more may effectively prevent the occurrence of irregularity on the surface of the adhesive composition due to magnetic force lines and also effectively reduce the magnetic force because distances among magnetic powder particles are extended. The volume change ratio being 400% or less allows the shear force after heating to be easily maintained within a desired range, and may prevent the resin collapse of the adhesive composition. The measurement of the volume change ratio can be conducted by using a method of actually measuring dimensions or by using well-known measurement apparatus such as a differential pressure type volume measurement apparatus.

The adhesive composition according to the present embodiment may preferably have a shear force after heating for adhesion of 20 N or more, more preferably of 30 N or more, further preferably of 50 N or more, particularly preferably of 70 N or more, and most preferably of 100 N or more. The shear force after heating for adhesion as used herein refers to a shear force measured in conformity with JIS K6850 for the adhesive composition which has been formed in sheet-like shape with a thickness of 500 μm to be interposed between two stainless steel plates and heated at 150° C. during 40 minutes thereafter being returned to ordinary temperature.

As described above, the adhesive composition according to the present embodiment has a high surface magnetic force at ordinary temperature before being heated and can thus be temporarily fixed only by its surface magnetic force to a member comprising a ferromagnetic material. The adhesive composition according to the present embodiment, before being heated, has no tack or almost no tack and can therefore be easily repositioned even if the position of temporarily fixing is misaligned from a predetermined position.

Furthermore, the adhesive composition according to the present embodiment develops a strong adhesive force by heating thereby to tightly adhere to the member (adherend) to which it has been temporarily fixed. In addition, the adhesive composition may be returned to ordinary temperature after being heated so that the surface magnetic force is significantly reduced, and hence it is possible to efficiently suppress the negative effect of the magnetic force to the member as an adherend, human body, or an electronic device. Further, it is also possible to suppress the occurrence of irregularity on the surface due to magnetic force lines after heating.

The adhesive composition according to the present embodiment may be used for bonding a member and another member that comprises a material exhibiting ferromagnetic property with each other or for bonding members both comprising materials that exhibit ferromagnetic property with each other. The member comprising a material that exhibits ferromagnetic property may include a material that contains iron, cobalt, and nickel. Specific examples of such a member include automotive parts such as steel sheets for automobile doors and bodies, closing plates for the steel sheets, reinforcing components for car bodies.

The adhesive composition according to the present embodiment may be provided as a molded body that has a predetermined shape necessary for bonding members to each other as the above. Specific examples of the shape of the molded body include: sheet-like bodies (representing the hot-melt adhesive sheet of the present invention) having various shapes, such as triangle, quadrangle, pentagon, hexagon, octagon and other polygonal shapes, circle, ellipse and other circle-like shapes, and ring-like shapes obtained by removing the center portions of the above shapes; plate-like bodies; block-like bodies; pillar-like bodies; and rod-like bodies.

The thickness of the sheet-like body (hot-melt adhesive sheet) may be preferably 0.3 to 20 mm in general, and more preferably 0.5 to 10 mm.

The adhesive composition according to the present embodiment may be molded or shape formed by various methods, such as a method in which the adhesive composition is heated to be in a fluidized state thereafter being applied to a release surface of a release sheet, and obtained sheet-like body is cut into a predetermined shape, a method in which the adhesive composition is heated to be in a fluidized state thereafter being applied to the surface of a desired member (which may be or may not be a ferromagnetic substance), and a method in which the adhesive composition is molded to a desired shape using an injection molding machine.

It is preferred that the heating temperature for the adhesive composition in the above molding or shape forming method may be a temperature equal to or higher than the softening point of the hot-melt adhesive and equal to or lower than the foaming start temperature of the foaming agent, and specifically 130° C. to 170° C. in a preferable example. It is also preferred that the injection molding temperature may be 130° C. to 170° C. when the adhesive composition is subjected to injection molding.

As the release sheet to be used for shape forming of the sheet-like body (hot-melt adhesive sheet), a release sheet with both surfaces subjected to release treatment or a release sheet with one surface subjected to release treatment may be used. For example, such a release sheet may be one obtained by applying a release agent such as silicone resin to a paper base material such as glassine paper, coat paper and high-quality paper, to a laminated paper obtained by laminating a thermoplastic resin such as polyethylene on the paper base material, or to a plastic film such as polyethylene terephthalate resin, polybutylene terephthalate resin, polyethylene naphthalate resin or other polyester resin film, and polypropylene resin, polyethylene resin or other polyolefin resin film. The thickness of this release sheet may be, but not limited to, preferably 20 to 200 μm.

Here, the adhesion method according to one embodiment of the present invention will be described.

As a first example, a method will be described in which a first member comprising a ferromagnetic material and a second member comprising a ferromagnetic material are caused to adhere to each other via the above hot-melt adhesive sheet between bonding surfaces thereof. First, the hot-melt adhesive sheet is prepared to have a shape corresponding to the bonding surfaces of the first member and the second member. The hot-melt adhesive sheet is interposed between the bonding surfaces of these two members so that the first member and the second member are temporarily fixed to each other by means of the magnetic force of the hot-melt adhesive sheet. Further, the hot-melt adhesive sheet is heated and then cooled to cause the first member and the second member to strongly adhere to each other. The shapes of the first member and the second member are not particularly limited.

As a second example, a method will be described in which a first member and a second member that comprises a ferromagnetic material are caused to adhere to each other via the hot-melt adhesive composition between bonding surfaces thereof. First, an adhesive portion comprising the hot-melt adhesive composition is formed on the first member. The forming method for the adhesive portion may be such that the hot-melt adhesive composition heated to be in a fluidized state is applied to the first member, or such that the first member is stacked on the hot-melt adhesive composition formed in a sheet-like shape and heated to be molten. The first member may be or may not be a ferromagnetic substance.

Subsequently, the adhesive portion formed on the first member is caused to adsorb to the second member by means of the surface magnetic force of the adhesive portion so that the first member and the second member are temporarily fixed to each other. Further, the hot-melt adhesive composition is heated and then cooled to cause the first member and the second member to strongly adhere to each other.

The heating temperature for the hot-melt adhesive sheet or the hot-melt adhesive composition is a temperature which is equal to or higher than the temperature where the hot-melt adhesive develops an adhesive force and which is equal to or higher than the foaming temperature of the foaming agent. Specifically, the heating temperature may be preferably 110° C. to 200° C., more preferably 120° C. to 180° C., and most preferably 130° C. to 170° C.

The adhesive composition according to the present embodiment has a magnetic force at ordinary temperature before being heated, and can thus be applied to various members/components if at least one of two members to be bonded comprises a ferromagnetic material.

The hot-melt adhesive composition or the molded or shape-formed body thereof as described above has almost no tack in the initial stage and can therefore be easily repositioned to the correct position even if the alignment of the position where the adherend is applied is incorrect, thus having superior workability. A strong adhesive force can be obtained by heating and the strong adhesive force may be maintained even after the temperature is returned to ordinary temperature, so that the adherend can be steadily fixed. The temporarily fixing force caused by the magnetic force in the initial stage is sufficiently high while the magnetic force is sufficiently reduced after heating, and the negative effect due to the magnetic force after heating can thus be prevented. It is also possible to suppress the occurrence of irregularity on the surface due to magnetic force lines after heating.

It should be appreciated that the embodiments heretofore explained are described to facilitate understanding of the present invention and are not described to limit the present invention. Therefore, it is intended that the elements disclosed in the above embodiments include all design changes and equivalents to fall within the technical scope of the present invention.

### EXAMPLES

The present invention will hereinafter be further specifically described with reference to examples, but the scope of the present invention is not to be limited to these examples.

### Example 1

### 1. Preparation of Hot-Melt Adhesive Composition

The hot-melt adhesive composition was obtained by using 200 parts by mass of strontium ferrite powder (average particle diameter of 2 μm) as the magnetic powder, 99.3 parts by mass of polyester resin-based hot-melt adhesive (available from TOYO ADL CORPORATION, trade name “ER-6701”, softening point of 80° C.), and 0.7 parts by mass of thermally expandable microcapsule (available from Japan Fillite Co., Ltd., trade name “Expancel 930-DU-120”, foaming start temperature of 122° C. to 132° C.), which were put into a mixer (available from PRIMIX Corporation, trade name “T. K. HIVIS MIX 2P-1”) to be heated to 100° C. and mixed during 30 minutes. Compounding ratio of each component in this hot-melt adhesive composition is listed in Table 1.

### 2. Preparation of Hot-Melt Adhesion Sheet with Release Sheet

As the release sheet, a polyethylene terephthalate resin sheet (available from LINTEC Corporation, trade name “SP-PET 100 (T)”, thickness of 100 μm) was prepared, the surface thereof being subjected to silicone release treatment.

The hot-melt adhesive was extruded on the release treated surface of the release sheet from the die with an extruder at extruding temperature of 120° C. to form an adhesive layer having a thickness of 500 μm, then cooled to ordinary temperature.

Finally, magnetization was performed with a high-voltage capacitor-type magnetizing/demagnetizing power-supply apparatus (available from Magnet Labo Co., Ltd., trade name “PC-2520ND”) under the condition of a voltage of 500 V and a current of 8 kA to give a hot-melt adhesive sheet with release sheet.

### Example 2

A hot-melt adhesive sheet with release sheet was obtained in the same manner as Example 1 except for changing the additive amount of the thermally expandable microcapsule to 1.3 parts by mass.

### Example 3

A hot-melt adhesive sheet with release sheet was obtained in the same manner as Example 1 except for changing the additive amount of the thermally expandable microcapsule to 3.3 parts by mass.

### Example 4

A hot-melt adhesive sheet with release sheet was obtained in the same manner as Example 1 except for changing the additive amount of the thermally expandable microcapsule to 6.5 parts by mass.

### Example 5

A hot-melt adhesive sheet with release sheet was obtained in the same manner as Example 1 except for changing the polyester resin-based hot-melt adhesive to “SR-100” (softening point of 100° C.) available from The Nippon Synthetic Chemical Industry Co., Ltd. and also changing the thermally expandable microcapsule to “Expancel 950-DU-120” (foaming start temperature of 138° C.) available from Japan Fillite Co., Ltd.

### Example 6

A hot-melt adhesive sheet with release sheet was obtained in the same manner as Example 5 except for changing the additive amount of the thermally expandable microcapsule to 1.3 parts by mass.

### Comparative Example 1

A hot-melt adhesive sheet with release sheet was obtained in the same manner as Example 1 except for not adding any thermally expandable microcapsule.

### Comparative Example 2

A hot-melt adhesive sheet with release sheet was obtained in the same manner as Example 5 except for not adding any thermally expandable microcapsule.

### Comparative Example 3

A hot-melt adhesive sheet with release sheet was obtained in the same manner as Example 1 except for changing the additive amount of the thermally expandable microcapsule to 12.0 parts by mass.

With respect to the hot-melt adhesive composition and the hot-melt adhesive sheet with release sheet each obtained in the above examples and comparative examples, evaluation tests were conducted as below. The results are shown in Table 2.

### Exemplary Test 1

### Shear Force Measurement

The adhesive layer of the hot-melt adhesive sheet with release sheet each obtained in the examples and the comparative examples was applied to a stainless steel plate (thickness of 3 mm) and heated at 150° C. during 40 minutes thereafter being returned to ordinary temperature and released therefrom the release sheet, then the shear force (N) was measured in conformity with JIS K6850. The test speed was 300 ram/min.

### Exemplary Test 2

### Surface Magnetic Force Measurement

The release sheet was removed from the adhesive layer of the hot-melt adhesive sheet with release sheet each obtained in the examples and the comparative examples, and the surface magnetic force (mT) at ordinary temperature before heating was measured at a location separate by 1 cm from the surface of the adhesive layer using a gaussmeter (available from TOYO Corporation, trade name “5080-type Handy Gaussmeter”). In addition, the hot-melt adhesive sheet with release sheet was heated at 150° C. during 40 minutes thereafter being returned to ordinary temperature and released therefrom the release sheet, then the surface magnetic force (mT) at ordinary temperature after heating was measured at a location separate by 1 cm from the surface of the adhesive layer using the gaussmeter.

### Exemplary Test 3

### Volume Change Ratio Measurement

The hot-melt adhesive sheet with release sheet each obtained in the examples and the comparative examples was released therefrom the release sheet and cut out into 100 mm width×100 mm length, and the volume of the adhesive layer was measured as the volume before heating. Subsequently, after heated at 150° C. during 40 minutes and then returned to ordinary temperature, the volume of the adhesive layer was measured as the volume after heating. The measurement of the volume change ratio was performed by a method of actually measuring dimensions. The volume change ratio (%) due to heating was calculated on the basis of the above measurement results using the equation below.

Volume change ratio due to heating=(Volume after heating/Volume before heating)×100

### Exemplary Test 4

### Evaluation of Presence or Absence of Irregularity on the Surface Due to Magnetic Force Lines

The hot-melt adhesive sheet with release sheet each obtained in the examples and the comparative examples was heated at 150° C. during 40 minutes and then returned to ordinary temperature. The surface of the adhesive layer in the hot-melt adhesive sheet was visually observed, and the presence or absence of irregularity on the surface due to magnetic force lines was confirmed:

o: Irregularity due to magnetic force lines present;

x: Irregularity due to magnetic force lines absent.

TABLE 1

| | | | Thermally | | Magnetic |
|---|---|---|---|---|---|
| | | | expandable | | powder |
| | | | microcapsule | | Strontium |
| | Hot-melt adhesive | | 930-DU- | | ferrite |
| | ER-6701 | SR-100 | 120 | 950-DU-120 | powder |
| Example 1 | 99.3 | | 0.7 | | 200 |
| Example 2 | 98.7 | | 1.3 | | 200 |
| Example 3 | 96.7 | | 3.3 | | 200 |
| Example 4 | 93.5 | | 6.5 | | 200 |
| Example 5 | | 99.3 | | 0.7 | 200 |
| Example 6 | | 98.7 | | 1.3 | 200 |
| Comparative | 100 | | | | 200 |
| Example 1 | | | | | |
| Comparative | | 100 | | | 200 |
| Example 2 | | | | | |
| Comparative | 88.0 | | 12.0 | | 200 |
| Example 3 | | | | | |

TABLE 2

| | Volume | | | | Presence or |
|---|---|---|---|---|---|
| | change | | | | absence of |
| | ratio | | Surface magnetic | | irregularity |
| | (150° C., | Shear | force (mT) | | due to |
| | after | force | Before | After | magnetic |
| | 40 min.) | (N) | heating | heating | force lines |
| Example 1 | 132 | 200 | 29.8 | 3.5 | ∘ |
| Example 2 | 175 | 136 | 30.8 | 1.9 | ∘ |
| Example 3 | 250 | 70 | 30.6 | 0 | ∘ |
| Example 4 | 305 | 50 | 30.1 | 0 | ∘ |
| Example 5 | 112 | 590 | 32.7 | 0 | ∘ |
| Example 6 | 122 | 747 | 31.0 | 0 | ∘ |
| Comparative | 100 | 206 | 31.0 | 15.7 | x |
| Example 1 | | | | | |
| Comparative | 100 | 660 | 34.9 | 18.0 | x |
| Example 2 | | | | | |
| Comparative | 450 | 15 | 29.6 | 0 | ∘ |
| Example 3 | | | | | |

As shown in Table 2, the hot-melt adhesive sheet with release sheet each obtained in the examples exhibited a sufficient magnetic force for temporarily fixing at the initial stage, and the magnetic force was sufficiently reduced after heating and there was no occurrence of irregularity on the surface due to magnetic force lines after heating. In particular, the hot-melt adhesive sheet with release sheet in each of Examples 1 to 6 exhibited a sufficient shear force because of having a volume change ratio within a predetermined range. In the hot-melt adhesive sheet with release sheet each obtained in Comparative Examples 1 and 2, the magnetic force remained even after heating, and there was occurrence of irregularity on the surface due to magnetic force lines after heating, because no thermally expandable microcapsule was added. In addition, the hot-melt adhesive sheet with release sheet obtained in Comparative Example 3 had a small shear force after heating because the volume change ratio was unduly large.

### INDUSTRIAL APPLICABILITY

The present invention can be preferably utilized for bonding a member and another member (e.g., steel sheet for cars) that comprises a ferromagnetic material to each other or bonding members both comprising ferromagnetic materials to each other.

1. A hot-melt adhesive composition comprising a hot-melt adhesive, a ferromagnetic substance, and a foaming agent that foams when heated, the hot-melt adhesive composition having:
a surface magnetic force of 20 mT or more;
a surface magnetic force after heating for adhesion of 5 mT or less; and
a volume change ratio due to heating for adhesion of 110% to 400%.

2. The hot-melt adhesive composition as set forth in claim 1, wherein the foaming agent has a foaming start temperature higher than a softening point of the hot-melt adhesive by 10° C. or more.

3. The hot-melt adhesive composition as set forth in claim 1, wherein the foaming agent is a thermally expandable microcapsule.

4. A hot-melt adhesive sheet configured by forming the hot-melt adhesive composition as set forth in claim 1 into a sheet-like shape.

5. An adhesion method comprising:
temporarily fixing a first member and a second member to each other via the hot-melt adhesive sheet as set forth in claim 4, the first member comprising a ferromagnetic material, the second member comprising a ferromagnetic material; and
thereafter heating the hot-melt adhesive sheet to develop an adhesive force of the hot-melt adhesive composition and to foam the foaming agent so that the first member and the second member adhere to each other.

6. An adhesion method comprising:
forming an adhesive portion on a first member, the adhesive portion comprising the hot-melt adhesive composition as set forth in claim 1;
temporarily fixing the first member and a second member to each other via the adhesive portion, the second member comprising a ferromagnetic material; and
thereafter heating the adhesive portion to develop an adhesive force of the hot-melt adhesive composition and to foam the foaming agent so that the first member and the second member adhere to each other.

7. The hot-melt adhesive composition as set forth in claim 2, wherein the foaming agent is a thermally expandable microcapsule.

8. A hot-melt adhesive sheet configured by forming the hot-melt adhesive composition as set forth in claim 2 into a sheet-like shape.

9. A hot-melt adhesive sheet configured by forming the hot-melt adhesive composition as set forth in claim 3 into a sheet-like shape.

10. An adhesion method comprising:
forming an adhesive portion on a first member, the adhesive portion comprising the hot-melt adhesive composition as set forth in claim 2;
temporarily fixing the first member and a second member to each other via the adhesive portion, the second member comprising a ferromagnetic material; and
thereafter heating the adhesive portion to develop an adhesive force of the hot-melt adhesive composition and to foam the foaming agent so that the first member and the second member adhere to each other.

11. An adhesion method comprising:
forming an adhesive portion on a first member, the adhesive portion comprising the hot-melt adhesive composition as set forth in claim 3;
temporarily fixing the first member and a second member to each other via the adhesive portion, the second member comprising a ferromagnetic material; and
thereafter heating the adhesive portion to develop an adhesive force of the hot-melt adhesive composition and to foam the foaming agent so that the first member and the second member adhere to each other.
